(19) United States
(12) Patent Application Publication
(10) Pub. No.: US 2026/0218387 A1
(43) Pub. Date: Jul. 30, 2026

(54) Rust Prevention Method For Steel Material

(71) Applicant: JDC Corporation, Minato-Ku, Tokyo (JP)

(72) Inventors: Tadashi Yamauchi, Tokyo (JP); Masakazu Furuta, Tokyo (JP); Mutsuhiro Ohno, Tokyo (JP)

(21) Appl. No.: 19/112,062

(22) PCT Filed: Jul. 26, 2023
(86) PCT No.: PCT/JP2023/027447

§ 371 Date: Mar. 14, 2025

(30) Foreign Application Priority Data
Oct. 25, 2022 (JP) 2022-170688

(51) Int. Cl. C23F 11/06; C08K 3/28; C09D 5/16; C09D 7/61; C23F 11/173

(52) U.S. Cl. CPC C23F 11/06; C09D 5/1618; C09D 7/61; C23F 11/173; C08K 3/28

(57) ABSTRACT

A rust prevention method for a steel material includes directly applying a rust inhibitor containing a resin and a layered double hydroxide represented by a layered double hydroxide having a chemical formula represented by M²⁺₁₋ₓM³⁺ₓ(OH)₂(NO₃⁻)_{x/n}·mH₂O, wherein M²⁺ represents a divalent metal, M³⁺ represents a trivalent metal, and n is a natural number, to a steel material to which salt adheres, thereby preventing corrosion of the steel material due to the salt.

### TECHNICAL FIELD

The present invention relates to a rust prevention method for a steel material.

### BACKGROUND

Reinforced concrete is a structure in which reinforcing bars having a high tensile strength and concrete having a high compressive strength are used in combination. The reinforcing bar is easily oxidized to generate rust, but a passive film is formed on the surface of the reinforcing bar by highly alkaline cement contained in concrete. Therefore, the reinforcing bar inside the concrete does not corrode, and it is possible to continue to satisfy the required performance.

However, when a crack or the like occurs on the surface of concrete, a vicious cycle in which oxygen, moisture, or the like enters from the cracked portion, and further rust is generated occurs. Therefore, to prevent deterioration of reinforced concrete, a resinous coating material is applied to the concrete surface (see, for example, Japan Patent Publication No. JP 2014-083530 A).

### SUMMARY

When a reinforcing bar is corroded due to salt damage, concrete covering the corroded reinforcing bar is sometimes chipped to expose the reinforcing bar, and a rust inhibitor is applied to the surface of the reinforcing bar. As the rust inhibitor, for example, one containing nitrite ions (NO₂⁻) is known. When this type of rust inhibitor is used, a passive film (Fe₂O₃) is generated by a reaction between nitrite ions (NO₂⁻) and iron ions (Fe₂₊) to prevent corrosion of the reinforcing bar.

However, because nitrite ions (NO₂⁻) are used in an aqueous solution, there is a risk of exposure to the human body and environmental load (leakage)

An object of the present invention is to provide a rust prevention method for a steel material capable of preventing corrosion of a steel material due to salt.

A rust prevention method for a steel material according to the present invention includes a step of directly applying a rust inhibitor containing a resin and a layered double hydroxide represented by a layered double hydroxide having a chemical formula represented by M²⁺₁₋ₓM³⁺ₓ(OH)₂(NO₃⁻)_{x/n}·mH₂O (M²⁺ represents a divalent metal, M³⁺ represents a trivalent metal, and n is a natural number) to a steel material to which salt adheres.

According to the present invention, corrosion of a steel material due to salt can be prevented.

### BRIEF DESCRIPTION OF THE DRAWINGS

FIG. 1 includes diagrams for explaining a rust prevention method according to an embodiment.

FIGS. 2A to 2C are diagrams for explaining the action of a nitrate-type layered double hydroxide.

FIG. 3 is a diagram illustrating a crystallite structure of a nitrate-type layered double hydroxide.

FIGS. 4A to 4D are diagrams for explaining an example of an experiment for checking the action of a rust inhibitor.

FIG. 5 is a diagram illustrating the results of X-ray diffraction obtained with an X-ray diffractometer.

### DETAILED DESCRIPTION

Hereinafter, a rust prevention method for a steel material according to an embodiment will be described.

### Regarding Rust Inhibitor

First, the rust inhibitor used in the present embodiment will be described. The rust inhibitor of the present embodiment contains a resin having a function as a binder material and a layered double hydroxide.

### Resin

The resin is a resin that can cover the surface of concrete or a reinforcing bar and need only be a curable liquid resin that can prevent external moisture, chlorine, or the like from contacting the covered surface. As the resin, for example, an epoxy-based resin, an acrylic resin, a urethane-based resin, or the like can be used. These resins may be used alone, or two or more types thereof may be used in combination. The resin may be a one-component resin or a two-component resin.

### Epoxy-Based Resin

As the epoxy-based resin, for example, a bisphenol A type epoxy resin, a halogenated bisphenol A type epoxy resin, a bisphenol F type epoxy resin, a novolac type epoxy resin, a cresol novolac type epoxy resin, or the like can be used.

Examples of the bisphenol A type epoxy resin include polycondensates of bisphenol A type diglycidyl ethers such as bisphenol A diglycidyl ether, bisphenol A polypropylene oxide diglycidyl ether, bisphenol A ethylene oxide diglycidyl ether, hydrogenated bisphenol A diglycidyl ether, and hydrogenated bisphenol A propylene oxide diglycidyl ether. One type of such epoxy resins can be used, or two or more types thereof can be used in combination.

A reactive diluent can also be added to and blended with the epoxy-based resin. Such a reactive diluent is effective in reducing the viscosity of the composition. As such a reactive diluent, a compound having one epoxy group in a molecule, such as phenyl glycidyl ether, butyl glycidyl ether, allyl glycidyl ether, styrene oxide, or octylene oxide, can be used. Such a reactive diluent can also be blended in an amount of preferably 45 wt % or less, and preferably 25 wt % or less per main agent.

In the epoxy-based resin, a compound which does not have an epoxy group but can react with a component (such as an amine compound) of a curing agent can also be blended as an additive. As such a compound, an isocyanate such as hexamethylene diisocyanate or tolylene diisocyanate, and further an α,β-unsaturated carbonyl compound that undergoes a Michael addition reaction with an amine compound, for example, an acrylic acid ester or an acrylamide derivative can be used. The acrylic acid ester is effective in improving low-temperature curability, and the acrylamide derivative is effective in improving thixotropy or improving adhesiveness. Such an additive can be blended in a range of preferably 30 wt % or less, and more preferably 20 wt % or less per main agent.

In the epoxy resin, as other components, a plasticizer, a dye, an organic pigment, an inorganic filler, a polymer compound, an antioxidant, an ultraviolet absorber, a coupling agent, a surfactant, or the like can also be appropriately blended.

### Acrylic Resin

As the acrylic resin, for example, a polymer of an acrylic monomer or a copolymer of an acrylic monomer and another monomer can be used. Examples of the acrylic monomer include (meth)acrylic acid, C1-10 alkyl esters of (meth)acrylic acid such as methyl (meth)acrylate, ethyl (meth)acrylate, propyl (meth)acrylate, butyl (meth)acrylate, t-butyl (meth)acrylate, and hexyl (meth)acrylate, C3-12 cycloalkyl esters of (meth)acrylic acid such as cyclohexyl (meth)acrylate, aryl esters of (meth)acrylic acid such as phenyl (meth)acrylate, aralkyl esters of (meth)acrylic acid such as benzyl (meth)acrylate, hydroxy C2-6 alkyl (meth)acrylates such as 2-hydroxyethyl (meth)acrylate and 3-hydroxypropyl (meth)acrylate, alkylamino-alkyl(meth)acrylates such as dimethylaminoethyl (meth)acrylate, diethylaminoethyl (meth)acrylate, and diethylaminopropyl (meth)acrylate, (meth)acrylamides or derivatives thereof such as (meth)acrylamide, N-methyl (meth)acrylamide, methylol (meth)acrylamide, and alkoxymethyl (meth)acrylamide, epoxy group-containing (meth)acrylates such as glycidyl (meth)acrylate, and (meth)acrylonitrile.

Examples of the monomer copolymerized with the acrylic monomer include aromatic vinyl-based monomers such as styrene, a-methylstyrene, p-t-butylstyrene, and vinyltoluene, fatty acid vinyl ester-based monomers such as vinyl propionate, esters of unsaturated polycarboxylic acids such as maleic anhydride, maleic acid, fumaric acid, and itaconic acid or unsaturated polycarboxylic acid derivatives such as dimethyl maleate and diethyl fumarate, N-substituted maleimides such as N-phenylmaleimide, and olefinic monomers such as ethylene and propylene. These monomers may be used alone, or two or more types thereof may be used in combination.

### Urethane-Based Resin

As the urethane-based resin, for example, a urethane prepolymer having a free isocyanate group obtained by allowing a polyol and a polyisocyanate to react with each other can be used.

As the polyol, polyether polyol, polyolefin polyol, or the like can be used.

As the polyether polyol, it is appropriate to use a polyalkylene polyol having 2 to 4 hydroxy groups (active hydrogen groups) in a molecule obtained by addition polymerization of, preferably, an alkylene oxide having 2 to 8 carbon atoms such as ethylene oxide, propylene oxide, butylene oxide, or tetrahydrofuran to a polyol having 2 to 8 carbon atoms and having 2 or more, preferably 2 to 6 hydroxy groups such as ethylene glycol, propylene glycol, butanediol, diethylene glycol, glycerin, hexanediol, hexanetriol, glycerin, trimethylolpropane, or pentaerythritol in the presence of an alkali catalyst or the like.

As the polyolefin polyol, for example, it is appropriate to use a polydiene polyol having 2 to 4 hydroxy groups in a molecule obtained by addition polymerization of an alkylene oxide such as ethylene oxide, propylene oxide, butylene oxide, or tetrahydrofuran to a diene-based compound such as butadiene or isoprene. As the polyisocyanate, a compound having 2 or more, preferably 2 or 3 isocyanate groups in one molecule is appropriate.

Specific examples of the polyisocyanate include isocyanate compounds such as 2,4-toluene diisocyanate, 2,6-toluene diisocyanate, 4,4′-diphenylmethane diisocyanate, 2,4′-diphenylmethane diphenyl diisocyanate, carbodiimide-modified diphenylmethane diisocyanate, hexamethylene diisocyanate, xylylene diisocyanate, metaxylylene diisocyanate, 1,5-naphthalene diisocyanate, hydrogenated diphenylmethane diisocyanate, hydrogenated toluylene diisocyanate, hydrogenated xylylene diisocyanate, and isophorone diisocyanate; biuret polyisocyanate compounds such as Sumidur N (trade name, manufactured by Sumitomo Bayer Urethane Co., Ltd.); polyisocyanate compounds having an isocyanate ring such as Desmodur IL, HL (trade name, manufactured by Bayer AG) and Coronate E.H. (trade name, manufactured by Nippon Polyurethane Industry Co., Ltd.); adduct polyisocyanate compounds such as Sumidur L (trade name, manufactured by Sumitomo Bayer Urethane Co., Ltd.) and Coronate HL (trade name, manufactured by Nippon Polyurethane Industry Co., Ltd.). One type of these polyisocyanates can be used alone, or two or more types thereof can be used as a mixture.

### Layered Double Hydroxide

The layered double hydroxide is one having a chemical formula represented by M²⁺₁₋ₓM³⁺ₓ(OH)₂(NO₃⁻)_{x/n}·mH₂O. Here, M²⁺ represents a divalent metal, M³⁺ represents a trivalent metal, and n is a natural number. In addition, x is a number in the range of 0<x<1 and is generally a number in the range of ⅙<x<⅓. In the above, m is a number larger than 0. This layered double hydroxide is sometimes referred to as a hydrotalcite-like compound. Examples of the divalent metal ion (M²⁺) include Mg²⁺, Fe²⁺, Zn²⁺, Li²⁺, Ni²⁺, Co²⁺, and Cu²⁺. Examples of the trivalent metal ion (M³⁺) include Al³⁺, Fe³⁺, Cr³⁺, and Mn³⁺. The divalent metal ion (M²⁺) and the trivalent metal ion (M³⁺) included in the general formula need not be one type, and each metal ion may include a plurality of types.

Nitrate ions NO₃⁻ present between layers of the layered double hydroxide are exchanged for other anions having a higher affinity with the layered double hydroxide. The layered double hydroxide containing nitrate ions as in the present embodiment is referred to as a nitrate-type layered double hydroxide. When the nitrate-type layered double hydroxide adsorbs chloride ions (Cl⁻) from a reinforcing bar corroded due to salt damage, the nitrate-type layered double hydroxide releases nitrate ions NO₃⁻ instead. The released nitrate ions NO₃⁻ react with iron ions (Fe²⁺) to generate magnetite (Fe₃O₄), e.g., form black rust, according to the following reaction formula (1), thereby preventing corrosion of the reinforcing bar.

3Fe+8HNO₃→8NO₂+Fe₃O₄+4H₂O (1)

The layered double hydroxide according to the present embodiment can be Mg²⁺₁₋ₓAl³⁺ₓ(OH)₂(NO₃⁻)_{x/n}·mH₂O (Mg—Al type) in which the divalent metal ion (M²⁺) is Mg²⁺ and the trivalent metal ion (M³⁺) is Al³⁺, or Mg²⁺₁₋ₓFe³⁺ₓ(OH)₂(NO₃⁻)_{x/n}·mH₂O (Mg—Fe type) in which the divalent metal ion (M²⁺) is Mg²⁺ and the trivalent metal ion (M³⁺) is Fe³⁺, or Fe²⁺₁₋ₓFe³⁺ₓ(OH)₂(NO₃⁻)_{x/n}·mH₂O (Fe—Fe type) in which the divalent metal ion (M²⁺) is Fe²⁺ and the trivalent metal ion (M³⁺) is Fe³⁺. The Mg—Fe type is superior to the Mg—Al type in that the Mg—Fe type has a high specific gravity and is easy to separate by precipitation, and the raw material cost can be reduced.

The layered double hydroxide according to the present embodiment preferably has a crystallite size of 20 nm or less, more preferably 10 nm or less. For example, when the crystallite size of the layered double hydroxide is reduced to 20 nm or less, the specific surface area can be increased to 20 m²/g or more, and the adsorption performance can be improved.

The layered double hydroxide is synthesized by mixing an acidic solution containing a divalent metal ion and a trivalent metal ion with an alkaline solution. The layered double hydroxide synthesized here can have a larger specific surface area as the crystallite size is reduced. Therefore, it is preferable to shorten the aging time after synthesis, and it is preferable to neutralize at least within 120 minutes, preferably within 60 minutes after mixing the acidic solution and the alkaline solution, and more preferably simultaneously with mixing. Details of the synthesis method for the layered double hydroxide are described in Japan Patent Publication No. JP 2021-195276 A.

### Rust Prevention Method

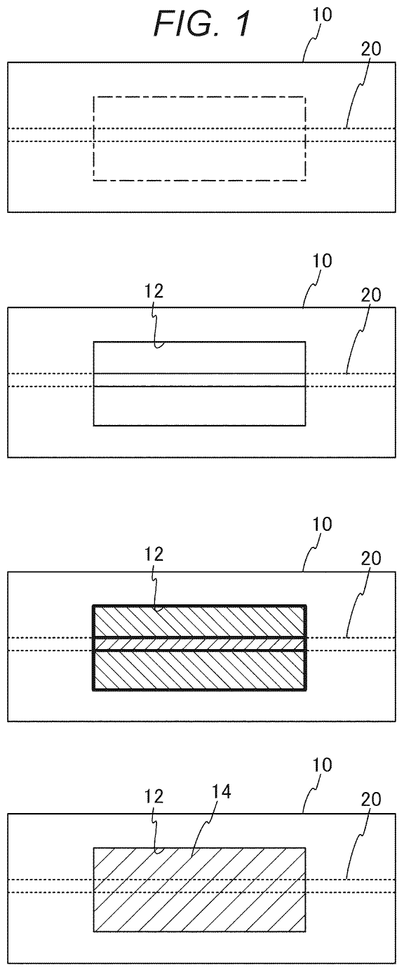

Next, with reference to FIG. 1, a rust prevention method (repair method) for a reinforcing bar when the reinforcing bar embedded in reinforced concrete (hereinafter referred to as a concrete structure) is damaged by salt will be described. The sequence of the rust prevention method is shown in order from the top to the bottom in FIG. 1.

As illustrated at the top of FIG. 1, in a case where there is a concrete structure 10 (e.g., made of a concrete material), it is assumed that a hammering test by an operator from outside reveals that a reinforcing bar 20 (a portion surrounded by a one-dot chain line) present inside the concrete structure 10 has been damaged by salt.

In this case, as next illustrated in FIG. 1, the operator chips a part of the concrete structure 10 (a portion damaged by salt) to expose the reinforcing bar 20 damaged by salt from the concrete structure 10 (see reference numeral 12). At this time, the concrete is removed so that the back surface side of the reinforcing bar 20 is also exposed.

Subsequently, as next illustrated in FIG. 1, the operator directly applies the rust inhibitor (a rust inhibitor containing a resin and a nitrate-type layered double hydroxide) of the present embodiment to the reinforcing bar 20 exposed from the concrete structure 10 and a concrete surface (chipped surface) exposed by chipping the concrete structure 10.

After the rust inhibitor is applied, the operator waits until a predetermined timing between when the rust inhibitor starts to cure and when the rust inhibitor cures completely is reached, and at the predetermined timing, as finally illustrated in FIG. 1, the operator uses a polymer cement mortar 14 to cover a chipped portion 12 and repairs the cross section. The predetermined timing is a timing when about one hour has elapsed after the rust inhibitor is applied, and the rust inhibitor is assumed to be in a sticky state (tacky state).

Here, when the resin contained in the rust inhibitor is a thermosetting resin, the time (waiting time) from when the rust inhibitor is applied to when the chipped portion 12 is covered with the polymer cement mortar 14 varies depending on the temperature at the site (the temperature around the reinforcing bar 20). When the temperature at the site is high, the waiting time becomes shorter, and when the temperature at the site is low, the waiting time becomes longer. Therefore, the operator may determine the waiting time based on the temperature at the site, and the operator may perform the final treatment of FIG. 1 at the stage when the waiting time has elapsed.

### Action of Nitrate-Type Layered Double Hydroxide

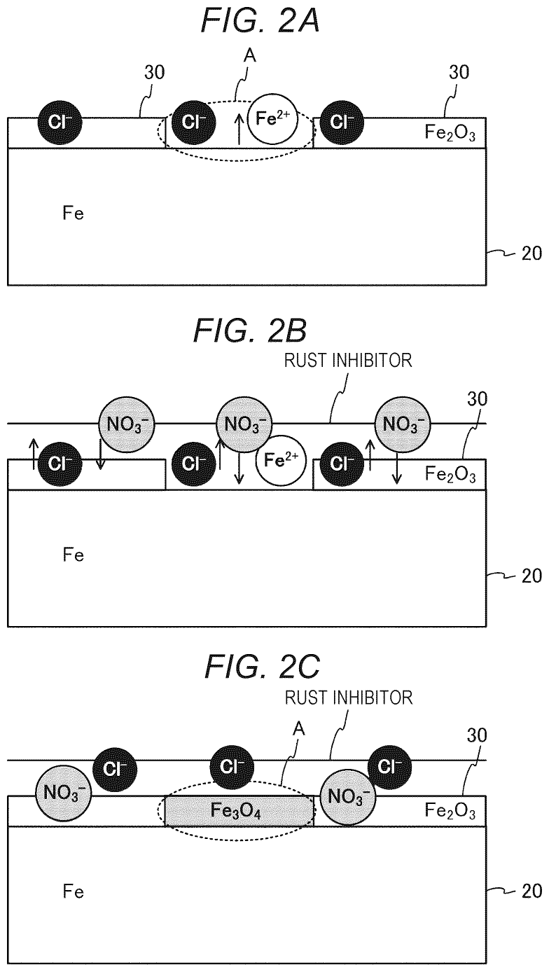

As described above, in the present embodiment, one containing a nitrate-type layered double hydroxide is used as the rust inhibitor. The action of the nitrate-type layered double hydroxide will be described with reference to FIGS. 2A to 2C.

FIG. 2A illustrates a state in which a part of the reinforcing bar 20 is corroded by chloride ions (Cl⁻). Usually, the surface of the reinforcing bar 20 in the concrete structure is covered with a passive film (Fe₂O₃) 30, and this effect prevents the occurrence of an oxidation reaction (corrosion). On the other hand, when the chloride ion concentration increases, the passive film disappears as indicated by the broken line ellipse A in FIG. 2A, and corrosion occurs.

When the rust inhibitor containing a nitrate-type layered double hydroxide is directly applied to the reinforcing bar 20 in a state where corrosion has occurred in a part of the reinforcing bar 20 as described above, as illustrated in FIG. 2B, the nitrate-type layered double hydroxide adsorbs chloride ions (Cl⁻) and releases nitrate ions (NO₃⁻) instead.

Due to the occurrence of the chemical reaction of the above reaction formula (1), magnetite (Fe₃O₄), that is, black rust is generated in a portion indicated by the broken line ellipse A in FIG. 2C. This makes it possible to prevent corrosion of the reinforcing bar. Here, it is important that the conditions for generation of magnetite (Fe₃O₄) by nitrate ions (NO₃⁻) are anaerobic environmental conditions and conditions (dry state) with as little H₂O as possible. In the present embodiment, because the rust inhibitor contains a resin as a binder material, the covered reinforcing bar surface after the rust inhibitor is applied becomes an anaerobic environment. In addition, because the resin does not contain moisture, the covered reinforcing bar surface becomes an environment with as little H₂O as possible. As described above, in the present embodiment, the condition that magnetite is easily generated is ensured in the portion covered with the rust inhibitor. In the present embodiment, it is preferable to make the surface of the reinforcing bar into a dry state (remove moisture) before the rust inhibitor is applied.

### Another Action of Nitrate-Type Layered Double Hydroxide

In addition, it is possible to further prevent corrosion of the reinforcing bar by using a metal ion having a higher ionization tendency than iron as at least one of the divalent metal ion or the trivalent metal ion of the nitrate-type layered double hydroxide. Hereinafter, a nitrate-type layered double hydroxide in which the divalent metal ion is Mg²⁺ and the trivalent metal ion is Al³⁺ will be described.

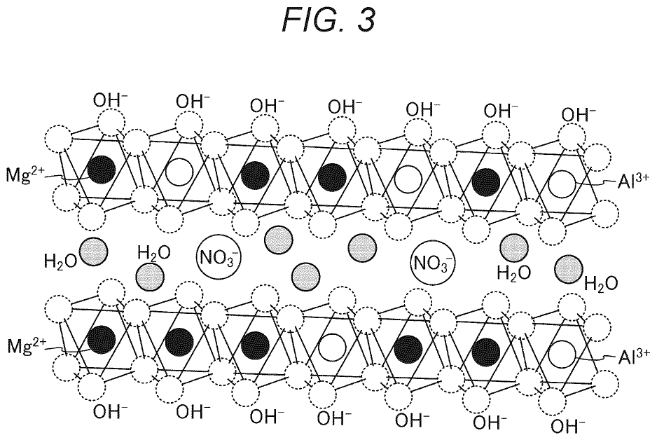

The crystallite structure of the nitrate-type layered double hydroxide has a structure as illustrated in FIG. 3. As illustrated in FIG. 3, the trivalent metal ions (Al³⁺) are not adjacent to each other in the crystallite and remain stable. However, when Al³⁺ ions located at the ends of the crystallites approach each other, the crystallites become unstable due to mutual repulsion, and each of the crystallites easily exhibits a property as Al. In particular, when the crystallite size is small (for example, 10 nm or less), Al³⁺ ions located at the ends of the crystallites easily approach each other and become unstable, and each of the crystallites more easily exhibits a property as Al.

Therefore, when a preservative containing the nitrate-type layered double hydroxide is applied to the reinforcing bar surface, a current flows between Al of each crystallite of the nitrate-type layered double hydroxide and the reinforcing bar (Fe) due to a difference in ionization tendency (electric potential difference) between Al and the reinforcing bar (Fe). Then, the metal (Al) having a high ionization tendency (low electric potential) is consumed, and the metal (Fe) having a low ionization tendency (high electric potential) is protected from rust (cathodic protection).

The same applies to Mg²⁺ located at the end of each of the crystallites, and by applying a preservative containing a nitrate-type layered double hydroxide to the reinforcing bar surface, a metal (Mg) having a high ionization tendency (low electric potential) is consumed, and a metal (Fe) having a low ionization tendency (high electric potential) is protected from rust.

In addition, because the hydroxide (Al(OH)₃) generated when Al³⁺ becomes unstable is an amphoteric hydroxide, the generation of red rust (Fe₂O₃) due to chloride ions is prevented, and the generation of magnetite (Fe₃O₄), that is, black rust, is promoted.

### Experimental Example

Hereinafter, an example of an experiment for checking the action of the rust inhibitor of the present embodiment will be described.

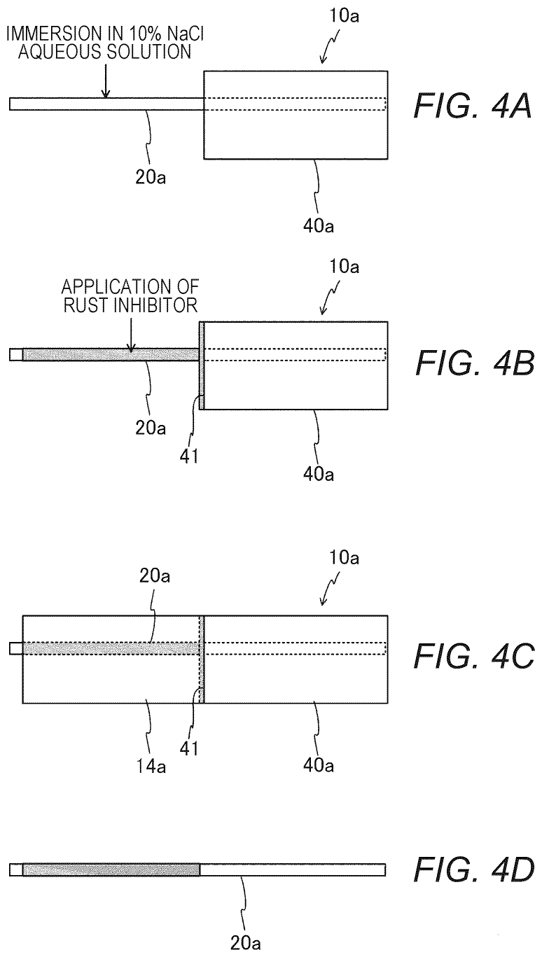

In this experiment, as illustrated in FIG. 4(a), a sample 10a in which a part of a D13 (diameter: about 13 mm) deformed reinforcing bar 20a was covered with concrete 40a was prepared. Then, the reinforcing bar portion not covered with the concrete was immersed once in a 10% NaCl aqueous solution. The chloride ion concentration of the concrete 40a was 5 kg/m³.

Subsequently, the reinforcing bar portion not covered with concrete was dried, and then as illustrated in FIG. 4B, a rust inhibitor containing a resin and a nitrate-type layered double hydroxide was directly applied to the portion of the reinforcing bar 20a not covered with the concrete 40a and a joint surface 41 of the concrete.

Subsequently, as illustrated in FIG. 4C, the portion coated with the rust inhibitor (reinforcing bar 20a, joint surface 41) was covered with a polymer cement mortar 14a. Thereafter, curing was performed in a constant temperature chamber at a temperature of 23° C. and a humidity of 60% for two and a half years.

Thereafter, as illustrated in FIG. 4D, the reinforcing bar 20a was chipped out, and a crystalline compound generated in the reinforcing bar portion coated with the rust inhibitor was estimated using an X-ray diffractometer.

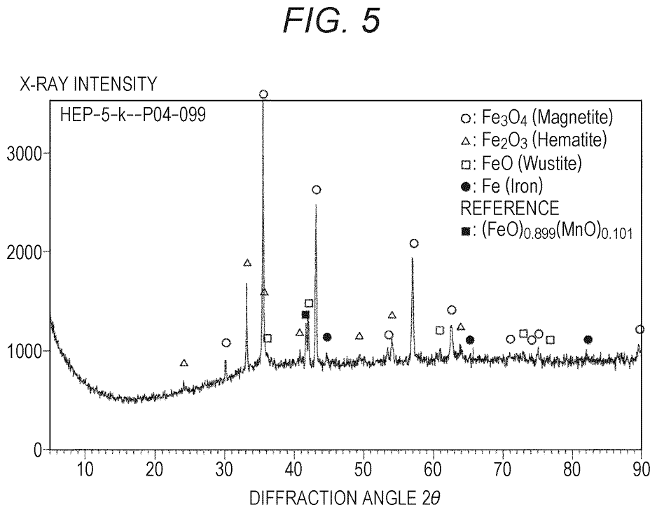

FIG. 5 illustrates the results of X-ray diffraction obtained with the X-ray diffractometer. In FIG. 5, the horizontal axis represents the diffraction angle 2θ (deg), and the vertical axis represents the X-ray intensity. From FIG. 5, it was found that magnetite (Fe₃O₄) was present in addition to Fe₂O₃, FeO, and Fe in the reinforcing bar portion coated with the rust inhibitor. That is, the present experiment demonstrated that the reaction of the above reaction formula (1) occurred in the reinforcing bar portion coated with the rust inhibitor.

As described above in detail, according to the present embodiment, when a reinforcing bar to which salt (chloride ion) adheres is subjected to a rust prevention treatment, a rust inhibitor containing a resin and a nitrate-type layered double hydroxide is directly applied. As a result, the nitrate-type layered double hydroxide applied to the reinforcing bar adsorbs chloride ions and releases nitrate ions, so that magnetite (Fe₃O₄), that is black rust, is generated on the surface of the reinforcing bar as in the above reaction formula (1). As a result, red rust is not generated on black rust, so that occurrence of corrosion in the reinforcing bar can be effectively prevented. Here, conventionally known rust inhibitors include a rust inhibitor of an aqueous solution containing nitrite ions. Such an aqueous solution containing nitrite ions has a risk of exposure to the human body and environmental load. On the other hand, in the case of the rust inhibitor of the present embodiment, although the rust inhibitor contains nitrate ions, the nitrate ions are fixed to the layered double hydroxide (solid) before application to a reinforcing bar. As a result, nitrate ions are released to the outside of the layered double hydroxide for the first time under an environment where chloride ions exist, and thus there is little risk of exposure to the human body or environmental load.

In addition, in the present embodiment, because the rust inhibitor contains a resin, a place where the rust inhibitor is applied can be made into an anaerobic environment and an environment with as little H₂O as possible. Thereby, the reaction of the above reaction formula (1) can be further promoted.

In addition, a conventionally known rust inhibitor sometimes uses a cementitious material as a binder material, but in the case of a rust inhibitor containing such a cementitious material, a treatment of repairing a cross section using a polymer cement mortar (see bottom or FIG. 1) cannot be performed unless curing is performed for, for example, 16 hours or more after application. This is because the polymer cement mortar cannot be applied when the cementitious material is in a semi-dry state. On the other hand, use of a resin as the binder material as in the present embodiment enables application of the polymer cement mortar even when the resin is in a semi-dry state (during a period between when the rust inhibitor starts to cure and when the rust inhibitor cures completely). Therefore, it is possible to perform the treatment of repairing the cross section using the polymer cement mortar (see bottom or FIG. 1) in a short time (for example, in about one hour) after the rust inhibitor is applied. Accordingly, the rust prevention work can be efficiently performed in a short time.

In addition, in the present embodiment, a metal having a higher ionization tendency than iron is used as at least one of the divalent metal and the trivalent metal of the layered double hydroxide, so that the occurrence of corrosion of a reinforcing bar can be more effectively prevented due to the cathodic protection function of the metal having a higher ionization tendency than iron.

In addition, in the present embodiment, by setting the crystallite size of the layered double hydroxide to 10 nm or less, the effect of the metal having a higher ionization tendency than iron located at the end of the crystallite can be made more pronounced. The present inventors checked that when a layered double hydroxide having a crystallite size of about 9.1 to 9.2 nm (measured using the result of X-ray diffractometry and the Scherrer equation) is used as the layered double hydroxide, the occurrence of corrosion of a reinforcing bar is reduced as compared with the conventional case (crystallite size of about 23 to 36 nm).

In the above embodiments, a case where a rust inhibitor containing a resin and a nitrate-type layered double hydroxide is applied to a reinforcing bar to perform a rust prevention treatment has been described, but the present invention is not limited thereto. The rust inhibitor may be applied to a steel material other than the reinforcing bar to perform a rust prevention treatment.

The above-described embodiments are preferred examples of the present invention. However, the present invention is not limited thereto, and various modifications can be made without departing from the scope of the present invention.

The following is a list of reference signs used in this specification and in the drawings.
10 Concrete structure
20 Reinforcing bar (steel material)
14 Polymer cement mortar

1. A rust prevention method for a steel material, comprising:
directly applying a rust inhibitor containing a resin and a layered double hydroxide represented by chemical formula M²⁺₁₋ₓM³⁺ₓ(OH)₂(NO₃⁻)_{x/n}·mH₂O to a steel material to which salt adheres, wherein M²⁺ represents a divalent metal, M³⁺ represents a trivalent metal, and n is a natural number.

2. The rust prevention method for a steel material according to claim 1, comprising:
covering the steel material with a concrete material during a period between when the rust inhibitor starts to cure and when the rust inhibitor cures completely.

3. The rust prevention method for a steel material according to claim 2, wherein
the resin contained in the rust inhibitor is a thermosetting resin, and
a time from when the rust inhibitor is applied to the steel material to when the steel material is covered with the concrete material varies depending on a temperature around the steel material.

4. The rust prevention method for a steel material according to claim 2, comprising:
chipping a part of a concrete structure in which the steel material is embedded to expose the steel material to which salt adheres from the concrete structure, wherein
directly applying the rust inhibitor, comprises directly applying the rust inhibitor to the steel material exposed from the concrete structure and a concrete surface exposed by chipping the concrete structure, and
covering the steel material comprises filling a portion resulting from chipping of the concrete structure with the concrete material.

5. The rust prevention method for a steel material according to claim 1, wherein the resin comprises at least one of an epoxy-based resin, an acrylic resin, or a urethane-based resin.

6. The rust prevention method for a steel material according to claim 1, wherein the layered double hydroxide adsorbs chloride ions to form black rust on a surface of the steel material.

7. The rust prevention method for a steel material according to claim 1, wherein at least one of the divalent metal or the trivalent metal of the layered double hydroxide has a higher ionization tendency than iron.

8. The rust prevention method for a steel material according to claim 7, wherein at least one of the divalent metal or the trivalent metal of the layered double hydroxide prevents the steel material from rusting by cathodic protection.

9. The rust prevention method for a steel material according to claim 7, wherein the layered double hydroxide has a crystallite size of 10 nm or less.

10. The rust prevention method for a steel material according to claim 2, comprising:
drying a surface of the steel material.

11. The rust prevention method for a steel material according to claim 10, comprising:
forming an anaerobic environment on a surface of the steel material by applying the resin to the surface of the steel material.

12. The rust prevention method for a steel material according to claim 2, comprising:
forming an anaerobic environment on a surface of the steel material by applying the resin to the surface of the steel material.
